(19) United States
(12) Patent Application Publication
(10) Pub. No.: US 2024/0191572 A1
(43) Pub. Date: Jun. 13, 2024

(54) Climbing Stick

(71) Applicant: Elevate Stand Co LLC, Hutchinson, KS (US)

(72) Inventor: Matthew Garcia, Hutchinson, KS (US)

(21) Appl. No.: 18/521,302

(22) Filed: Nov. 28, 2023

Related U.S. Application Data
(60) Provisional application No. 63/386,341, filed on Dec. 7, 2022.

(51) Int. Cl. E06C 1/38; E06C 1/34; E06C 7/50

(52) U.S. Cl. CPC E06C 1/381; E06C 1/34; E06C 7/50

(57) ABSTRACT

A set of climbing sticks for use in climbing a tree includes a first climbing stick having a support bar, a top foot rung secured to the support bar, a bottom foot rung secured to the support bar, an upper brace secured to and extending from the support bar, a lower brace secured to and extending from the support bar, and a magnet attached to the support bar; and a second climbing stick having a support bar, a top foot rung secured to the support bar, a bottom foot rung secured to the support bar, an upper brace secured to and extending from the support bar, and a lower brace secured to and extending from the support bar; the second climbing stick secures to the first climbing stick via the first magnet.

### CROSS-REFERENCE TO RELATED APPLICATION

This application claims the benefit of priority of U.S. Provisional Patent Application No. 63/386,341, filed on Dec. 7, 2022, the disclosure of which is herein incorporated by reference in its entirety.

### BACKGROUND

### 1. Field

Embodiments of the disclosure relate to climbing apparatuses, and in particular to climbing sticks for gaining an elevated position within a tree.

### 2. Related Art

Tree climbing apparatuses are known in the prior art. For example, U.S. Patent Publication No. 20120125715A1 to Furseth discloses a climbing stick with a support member, at least one bracket, and a pair of steps. U.S. Pat. No. 9,732,556B2 to Priest discloses a tree climbing stick system with first and second climbing sticks to secure to one another, and one or more claws for engaging with a tree. U.S. Pat. No. 5,752,580A to Jenkins discloses a modular ladder system with a support member and one or more steps extending therefrom, with one or more straps to secure to a tree. U.S. Pat. No. 8,556,035B1 to Kendall discloses a ladder module and securement system with a spine and multiple steps to secure to a tree via a strap or other flexible member.

### SUMMARY

This summary is provided to introduce a selection of concepts in a simplified form that are further described below in the detailed description. This summary is not intended to identify key features or essential features of the claimed subject matter, nor is it intended to be used to limit the scope of the claimed subject matter. Other aspects and advantages of the invention will be apparent from the following detailed description of the embodiments and the accompanying drawing figures.

In some aspects, the present invention described herein relates to a climbing stick for use in climbing a tree, comprising a support bar extending from a top end to a bottom end; a top foot rung secured to the support bar near the top end; a bottom foot rung secured to the support bar near the bottom end; an upper brace secured to and extending from the support bar; a lower brace secured to and extending from the support bar; and a strap receiver extending from the support bar in a direction opposite of the upper brace and the lower brace. The upper brace and the lower brace are configured to engage with a tree and a strap is configured to secure the climbing stick to the tree by wrapping around the tree and engaging with the strap receiver.

In other aspects, the present invention described herein relates to a set of climbing sticks for use in climbing a tree, the set of climbing sticks comprising a first climbing stick having a first support bar, a first top foot rung secured to the first support bar, a first bottom foot rung secured to the first support bar, a first upper brace secured to and extending from the first support bar, a first lower brace secured to and extending from the first support bar, and a first magnet attached to the first support bar; and a second climbing stick having a second support bar, a second top foot rung secured to the second support bar, a second bottom foot rung secured to the second support bar, a second upper brace secured to and extending from the second support bar, and a second lower brace secured to and extending from the second support bar. The second climbing stick is configured to secure to the first climbing stick via the first magnet.

### BRIEF DESCRIPTION OF THE DRAWING FIGURES

Embodiments of the invention are described in detail below with reference to the attached drawing figures, wherein:

FIG. 1 is a front view of an embodiment of a climbing stick in accordance with the present invention;

FIG. 2 is a side view of the climbing stick of FIG. 1;

FIG. 3 is an angled perspective view of the climbing stick of FIG. 1;

FIG. 4 is an angled perspective view of a set of climbing sticks stacked and secured together;

FIG. 5 is a rear angled perspective view of the set of climbing sticks of FIG. 4 stacked and secured together;

FIG. 6 is a side view of two embodiments of climbing sticks in accordance with the present invention; and

FIG. 7 is an angled perspective view of the climbing stick of FIG. 1 secured to a tree.

The drawing figures do not limit the invention to the specific embodiments disclosed and described herein. The drawings are not necessarily to scale, emphasis instead being placed upon clearly illustrating the principles of the invention.

### DETAILED DESCRIPTION

The following detailed description references the accompanying drawings that illustrate specific embodiments in which the invention can be practiced. The embodiments are intended to describe aspects of the invention in sufficient detail to enable those skilled in the art to practice the invention. Other embodiments can be utilized and changes can be made without departing from the scope of the invention. The following detailed description is, therefore, not to be taken in a limiting sense. The scope of the invention is defined only by the appended claims, along with the full scope of the equivalents to which such claims are entitled.

In this description, references to “one embodiment,” “an embodiment,” or “embodiments” mean that the feature or features being referred to are included in at least one embodiment of the technology. Separate references to “one embodiment,” “an embodiment,” or “embodiments” in this description do not necessarily refer to the same embodiment and are also not mutually exclusive unless so stated and/or except as will be readily apparent to those skilled in the art from the description. For example, a feature, structure, act, etc. described in one embodiment may also be included in other embodiments but is not necessarily included. Thus, the technology can include a variety of combinations and/or integrations of the embodiments described herein.

Climbing sticks are known in the art and provide a means for a user to climb a tree and gain an elevated viewpoint, such as may be desirable for hunting. A hunter may find an elevated position to be advantageous during the sport, and therefore many individuals use tree stands secured at the elevated position. Many trees are difficult to climb, and therefore difficult to reach or secure a tree stand at the desired position. This difficulty in the tree may be due to a lack of tree limbs, width of the trunk, or other features. Accordingly, an individual may use one or more climbing apparatuses to assist in reaching the elevated position.

One such type of climbing apparatus is a climbing stick, which ideally is lightweight and easily portable, such that the climbing stick is easy to transport for the hunter, as it is common for the hunter to hike a distance before settling on a location for hunting. Climbing sticks accordingly are generally compact enough for a user to transport and generally include a support, one or more steps, and a means to secure the stick along the tree.

Climbing sticks are also ideally durable, easy to use, and cause limited noise disturbances. For example, an ideal climbing stick would withstand weather and environmental conditions, and have the strength to support the user. In addition, the ideal climbing stick would require simple effort to use, such that the user would cause limited disruption in their environment. This would help ensure minimal disruptions to nearby wildlife. Yet further, in many instances, a user may use multiple climbing sticks to reach the desired elevated position. In this event, it is desirable to have climbing sticks that easily stack and secure together, to again make transport easy.

The climbing stick of the present disclosure comprises a support bar with a first foot rung near the top end of the support bar and a second foot rung near the bottom end of the support bar. The climbing stick further comprises an upper brace and a lower brace to engage with a tree as pressure is created via a one or more straps, or other similar devices. The climbing stick further comprises a means to secure multiple climbing sticks together, such as one or more magnets, thereby providing for easy transport of a set of climbing sticks and easy separation at the time of use. Further, the use of magnets will provide minimal noise as the multiple climbing sticks are separated from one another. The user will transport the climbing stick or sticks to a desired location, and accordingly, it is important that each climbing stick is compact and light enough to allow for easy transportation. In at least some embodiments, a selection of light-weight materials is used to construct the majority of components, e.g., lightweight metals or other materials, e.g., aluminum (6061-T6 aluminum) in embodiments, and allows for the climbing stick(s) to be easily carried and/or lifted by a user.

Once at the desired location, the user will utilize the strap(s) to secure the climbing stick(s) to the tree and engage one or more braces with a plurality of teeth against the tree, thereby creating a secure, friction engagement with the tree. In some situations, the user may utilize a second climbing stick at a second vertical position to allow for additional elevation. Yet further, the user may use a third, fourth, or any number of climbing sticks depending on the necessary vertical climb.

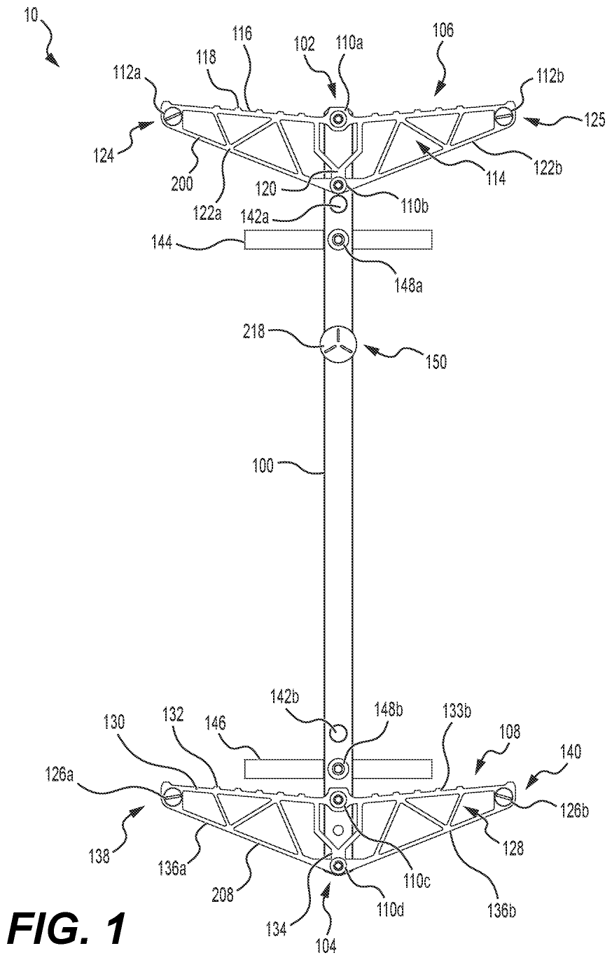

FIGS. 1, 2, and 3 show a first embodiment of a climbing stick 10 in accordance with the present invention. Climbing stick 10 includes a support bar 100 extending from a top end 102 to a bottom end 104. The support bar 100 may vary in length, thereby providing an appropriate fit for users of varying heights. Climbing stick 10 further includes a top foot rung 106 secured near the top end 102 and a bottom foot rung 108 secured near the bottom end 104. The top and bottom foot rungs 106, 108 may be secured to the support bar 100 via one or more bolts 110a-d or similar devices. In embodiments, a bottom bolt 110d is a long bolt, extending out from the bottom foot rung 108, this bottom bolt 110d providing for a location to secure one or more cables if desired by the user. In embodiments, this bottom bolt 110d extends out behind the bottom foot rung 108 a distance of at least one inch, however, alternative embodiments may vary.

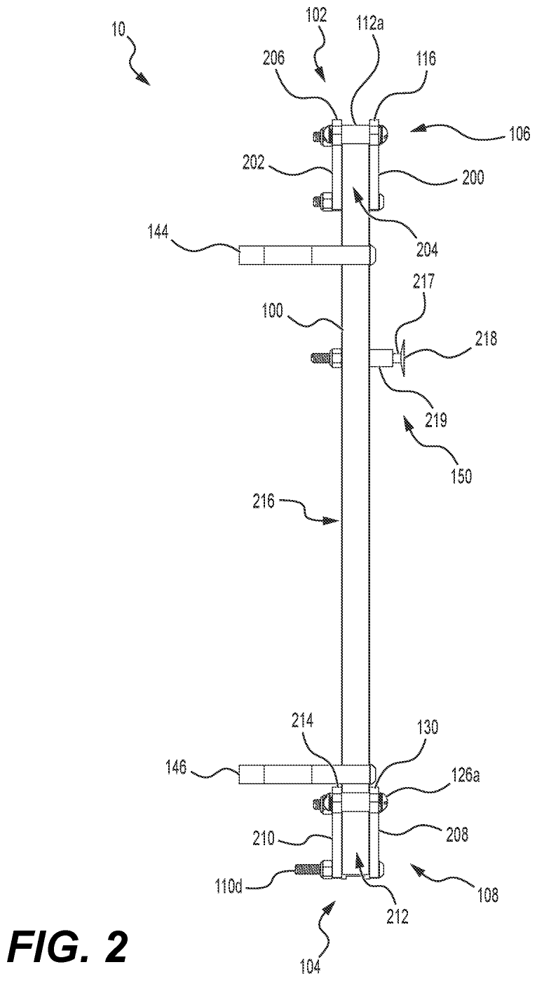

As best shown in FIG. 2, the top foot rung 106 includes a front side 200 and a back side 202 secured together via the one or more bolts 110a, 110b. A gap 204 is created between the front side 200 and the back side 202 as the support bar 100 is secured between the front side 200 and back side 202. The use of a front side 200 and a back side 202 with a gap therebetween, ensures that the user has two contact surfaces, i.e. top edges 116, 206 for engagement with their foot in use, while also reducing mass of the foot rung 106 and therefore an overall weight of the climbing stick 10. Having two contact surfaces specifically provides for stability in use, which improves safety associated with the climbing stick 10.

In addition, one or more spacers 112a, 112b extend through the gap 204. In embodiments, the one or more spacers 112a, 112b are rubber or a similar material. The use of spacers 112a, 112b, particularly at the outer corners of the front and back sides 200, 202, ensure that the foot rung 106 is structurally secure for stepping thereon. The front side 200 and the back side 202, in embodiments, are of the same shape and overall structure, each including a plurality of openings 114, 300 to aid in reducing an overall weight of the climbing stick 10. In addition, each of the front side 200 and back side 202 includes a top edge 116, 206 having a plurality of protrusions 118, 302 extending therefrom and providing for friction against a user's foot/shoe during use. The top foot rung 106, in embodiments, has a shape such that a center portion 120, where the top foot rung 106 is secured to the support bar 100, is the area of greatest height, and a bottom edge 122a, 122b generally angles upwards to corners 124, 125, where the spacers 112a, 112b are positioned.

Bottom foot rung 108 is configured substantially the same as top foot rung 106. Specifically, bottom foot rung 108 includes a front side 208 and a back side 210, spaced apart via a gap 212 such that the support bar 100 is secured therebetween, along with one or more spacers 126a, 126b. The front side 208 and the back side 210 of the bottom foot rung 108, in embodiments, are of the same shape and overall structure, each including a plurality of openings 128, 302 to aid in reducing an overall weight of the climbing stick 10. In addition, each of the front side 208 and back side 210 includes a top edge 130, 214 having a plurality of protrusions 132, 304 extending therefrom and providing for friction against a user's foot/shoe during use. The bottom foot rung 108, in embodiments, has a shape such that a center portion 134 is an area of greatest height, and a bottom edge 136a, 136b generally angles upwards to corners 138, 140, where the spacers 126a, 126b are positioned.

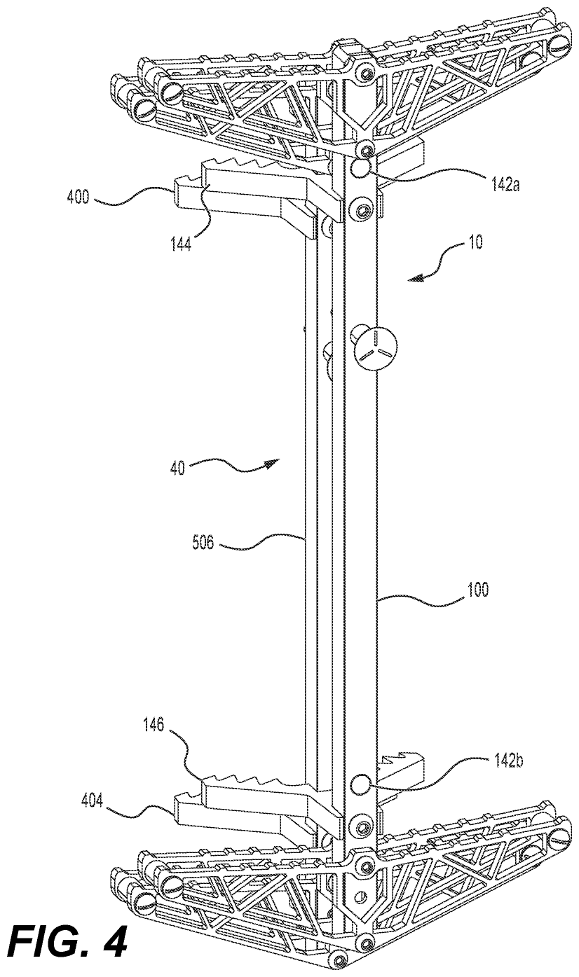

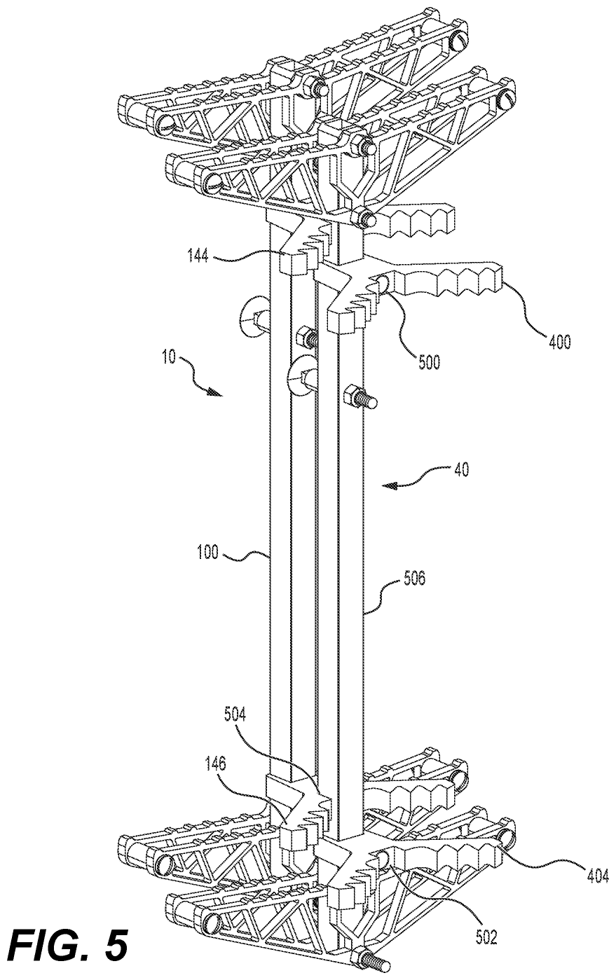

In embodiments, climbing stick 10 includes one or more magnets 142a, 142b positioned along the support bar 100. As would be understood by those skilled in the art, the one or more magnets 142a, 142b may be embedded within the support bar 100, secured (such as via an adhesive or similar means) to an exterior of the support bar 100, and/or may be spaced at varying positions along the support bar 100. The one or more magnets 142a, 142b provide for magnetic retention to a second climbing stick (see FIGS. 4 and 5) to allow for easy transport of multiple climbing sticks together as a set of climbing sticks.

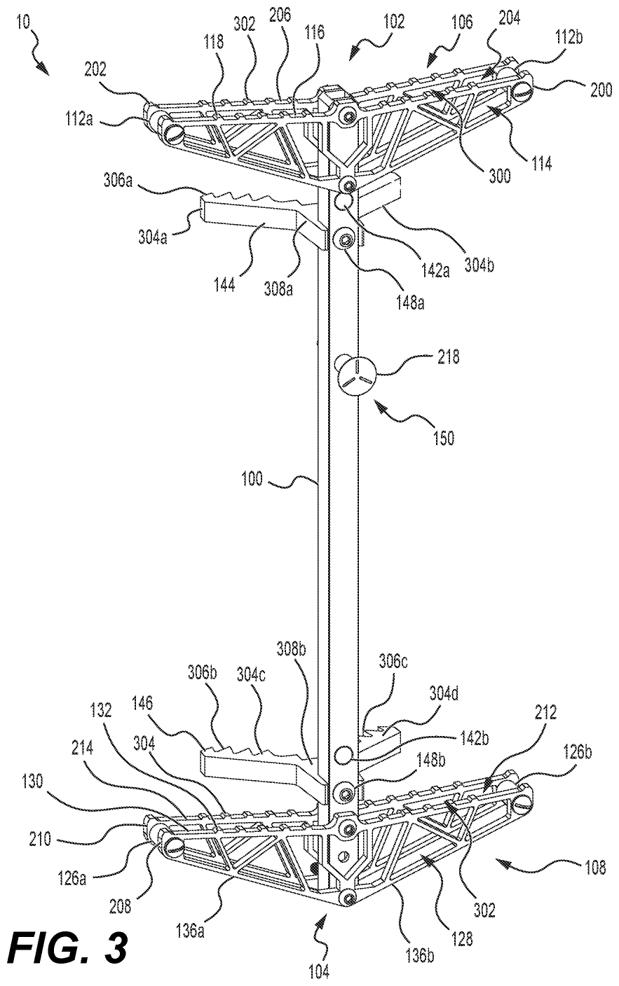

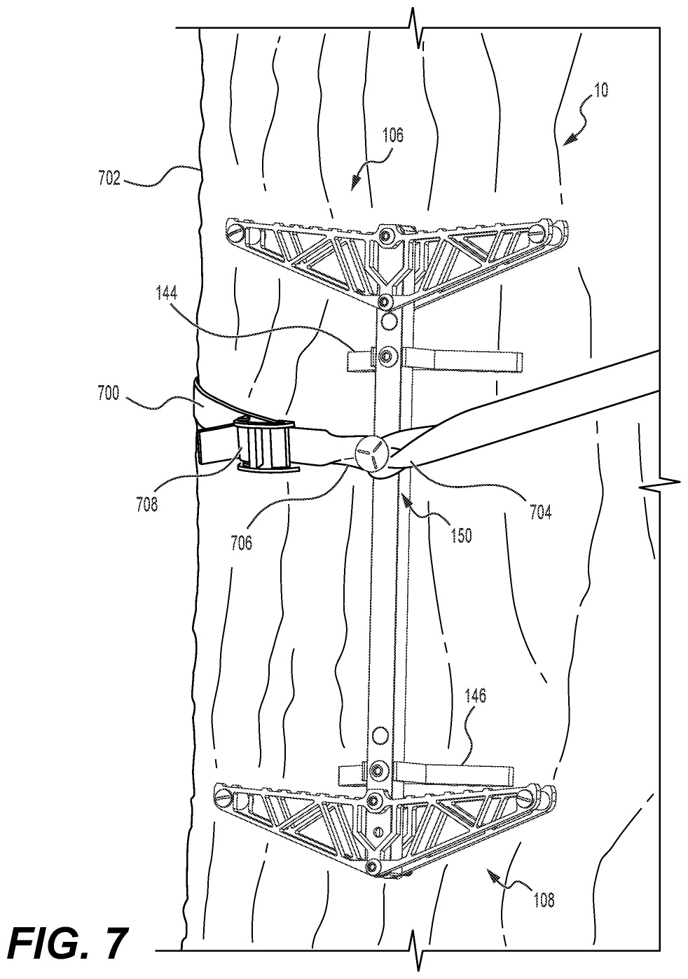

Climbing stick 10 further includes an upper brace 144 and a lower brace 146, the braces secured along the support bar 100 near the top end 102 and the bottom end 104 respectively, via bolts 148a, 148b or other devices as would be understood by those skilled in the art. The upper brace 144 and lower brace 146 extend away from a back surface 216 of support bar 100 and are configured to engage with a tree (see FIG. 7). As best shown in FIG. 3, each of the upper brace 144 and the lower brace 146 comprises outwardly angled, substantially-straight jaws 304a-d which support sets of teeth 306a-d, the jaws 304a-d extend out from a center connecting portion 308a-b. The angles of each of the jaws are selected to conform to an average tree diameter (more specifically, to be substantially tangential relative to an average tree diameter) such that the sets of teeth 306a-d are configured to engage with the tree to support the climbing stick 10 at the position above the ground surface.

Climbing stick 10 further includes a strap receiver 150 extending from the support bar 100 in a direction opposite the upper and lower braces 144, 146. The strap receiver 150 may vary in form, as would be understood by those skilled in the art. In embodiments, the strap receiver 150 includes a bolt 217 with a circular head 218 configured to receive a strap or other flexible member, such as via a hoop. A spacer 219, in embodiments, is used to extend the circular head 218 a distance away from the support bar 100. As shown best in FIG. 7, the strap 700 will loop onto the strap receiver 150, extend around the tree 702, and secure back to the strap receiver 150, wherein ratcheting or otherwise tightening the strap 700 secures the climbing stick 10 to the tree 702 creating a friction hold against the tree with the upper brace 144 and lower brace 146.

In FIG. 4, a front perspective view depicts two climbing sticks 10, 40 as a set of climbing sticks, engaged together via magnetic retention. Although two climbing sticks 10, 40 are shown, those skilled in the art would understand that additional climbing sticks may be added and further secured into a set. As shown, in embodiments, the set of climbing sticks 10, 40 are offset in the stack, such that an upper brace 400 of the bottom climbing stick 40 is positioned slightly below the upper brace 144 of the top climbing stick 10. Similarly, a lower brace 404 of the bottom climbing stick 40 is positioned slightly below the lower brace 146 of the top climbing stick 10. In embodiments, this alignment of stacking positions a first magnet (not shown) of the bottom climbing stick 40 with the upper brace 144 of the top climbing stick 10, and a second magnet (not shown) of the bottom climbing stick 40 with a lower brace 146 of the top climbing stick 10. Accordingly, the two magnets of the bottom climbing stick 40 create magnetic retention on the upper brace 144 and the lower brace 146. A third climbing stick (not shown) could be added such that an upper brace is positioned over magnet 142a of climbing stick 10 and a lower brace is positioned over magnet 142b of climbing stick 10. This configuration allows for the braces of each climbing stick in a stack to be slightly offset from a lower climbing stick, creating a compact stacked configuration.

In FIG. 5, a rear angled view further shows how the two climbing sticks 10, 40 can nest together. In embodiments, each brace 144, 146, 400, 404 includes an appropriately shaped channel, e.g. channels 500, 502, 504, to receive a support bar of a subsequent climbing stick. Accordingly, in embodiments, the channels 500, 502, 504 are rectangular in shape and sized marginally larger than the support bars, thereby receiving a rectangular support bar, e.g. support bar 506. Each channel partially wraps around the support bar of the stacked climbing stick, which helps retain the set of climbing sticks in the nested configuration. In other words, the channel 504 being partially wrapped around support bar 506 helps ensure that climbing stick 40 does not rotate or otherwise shift out of contact with climbing stick 10 until the user breaks the magnetic retention. Accordingly, the magnets (not shown) of the second climbing stick 40 are positioned to align with the channels of upper brace 144 and lower brace 146 of the first climbing stick, thereby creating magnetic retention within the channels and against the support bar 100.

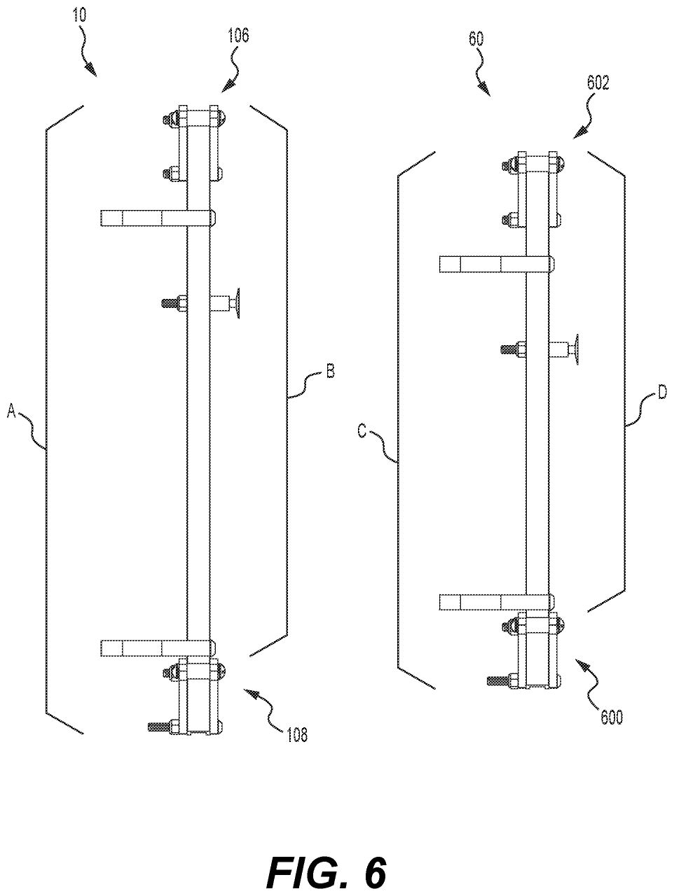

In FIG. 6, a side view depicts two climbing sticks 10, 60 in accordance with embodiments of the present invention. As shown, the climbing sticks 10, 60 can vary in size, particularly in height. Climbing stick 10 having a greater height than climbing stick 60 may provide more ease of use and comfort for a taller user, whereas climbing stick 60 may provide more ease of use for a shorter user. Although the exact lengths can vary, in embodiments, climbing stick 10 has a height (A) of approximately 20 inches and a step distance (B) between the top of bottom foot rung 108 and the top of top foot rung 106 of approximately 18 inches. Climbing stick 60 has a height (C) of approximately 17 inches and a step distance (D) between the top of a bottom foot rung 600 and the top of a top foot rung 602 of approximately 15 inches. Again, those skilled in the art would understand that an exact weight of either climbing stick 10, 60 can vary, however, in embodiments climbing stick 10 is approximately 1.75 pounds and climbing stick 60 is approximately 1.6 pounds.

FIG. 7 depicts climbing stick 10 secured to tree 702 via a strap 700. Although a ratchet strap is shown, those skilled in the art would understand that variable straps could be used. During use, a user will start by placing a first loop 706 of the strap 700 around the strap receiver 150. The strap 700 is then wrapped around the tree and a second loop 704 secures to the strap receiver 150. Keeping the strap 700 as parallel to the ground as possible, the user will tighten the strap 700 via a ratchet 708 (or similar tightening mechanism). This tightens the upper brace 144 and the lower brace 146 against the tree 702 such that the sets of teeth 306a-d dig into the tree 702 and create a friction hold against the tree 702. Once secured in place, the climbing stick 10 is used to gain a vertical position up the tree 702. The user will utilize the bottom foot rung 108 and the top foot rung 106 as steps going up the tree 702. As needed, the user can secure additional climbing sticks along the tree 10, such that the user can gain a higher elevation. For example, after the user secures climbing stick 10, the user can then stand on climbing stick 10 for support to then secure a second climbing stick above climbing stick 10 and proceed to climb.

Although the invention has been described with reference to the embodiments illustrated in the attached drawing figures, it is noted that equivalents may be employed and substitutions made herein without departing from the scope of the invention as recited in the claims.

Having thus described various embodiments of the invention, what is claimed as new and desired to be protected by Letters Patent includes the following:

1. A climbing stick for use in climbing a tree, comprising:
a support bar extending from a top end to a bottom end;
a top foot rung secured to the support bar near the top end;
a bottom foot rung secured to the support bar near the bottom end;
an upper brace secured to and extending from the support bar;
a lower brace secured to and extending from the support bar; and
a strap receiver extending from the support bar in a direction opposite of the upper brace and the lower brace;
wherein the upper brace and the lower brace are configured to engage with a tree; and
wherein a strap is configured to secure the climbing stick to the tree by wrapping around the tree and engaging with the strap receiver.

2. The climbing stick of claim 1, further comprising a first magnet attached to the support bar.

3. The climbing stick of claim 2, wherein the first magnet is attached to the support bar at a position between the upper brace and the top foot rung.

4. The climbing stick of claim 3, further comprising a second magnet attached to the support bar at a position above the lower brace.

5. The climbing stick of claim 1, wherein the top foot rung further comprises:
a front side having a first plurality of irregularly shaped openings extending therethrough, the front side having a first contact surface;
a back side having a second plurality of irregularly shaped openings extending therethrough, the back side having a second contact surface; and
one or more spacers positioned between the front side and the back side;
wherein the support bar is secured between the front side and the back side such that a gap is created between the front side and the back side; and
wherein the first contact surface and the second contact surface are configured to engage with a user's foot when in use.

6. The climbing stick of claim 5, wherein the front side and the back side each further comprise a top edge with a plurality of protrusions extending therefrom.

7. The climbing stick of claim 1, wherein the upper brace further comprises:
a connection portion extending around the support bar;
a channel integral with the connection portion;
a first jaw extending away from the channel and supporting a first plurality of teeth; and
a second jaw extending away from the channel and supporting a second plurality of teeth;
wherein the channel is configured to receive a second support bar associated with a second walking stick.

8. The climbing stick of claim 1, wherein the climbing stick further comprises a height of approximately 20 inches, a distance between a top of the top foot rung and a top of the bottom foot rung of approximately 18 inches, and a weight of approximately 1.75 pounds.

9. The climbing stick of claim 1, wherein the climbing stick further comprises a height of approximately 17 inches, a distance between a top of the top foot rung and a top of the bottom foot rung of approximately 15 inches, and a weight of approximately 1.6 pounds.

10. The climbing stick of claim 1, further comprising a long bolt extending through the bottom foot rung and the support bar, the long bolt extending outward from the bottom foot rung.

11. The climbing stick of claim 1, wherein the strap receiver further comprises a bolt with a circular head, the circular head being spaced away from the support bar via a spacer.

12. A set of climbing sticks for use in climbing a tree, the set of climbing sticks comprising:
a first climbing stick having a first support bar, a first top foot rung secured to the first support bar, a first bottom foot rung secured to the first support bar, a first upper brace secured to and extending from the first support bar, a first lower brace secured to and extending from the first support bar, and a first magnet attached to the first support bar; and
a second climbing stick having a second support bar, a second top foot rung secured to the second support bar, a second bottom foot rung secured to the second support bar, a second upper brace secured to and extending from the second support bar, and a second lower brace secured to and extending from the second support bar;
wherein the second climbing stick is configured to secure to the first climbing stick via the first magnet.

13. The set of climbing sticks of claim 12, wherein the first magnet is attached to the first support bar at a position between the first top foot rung and the first upper brace.

14. The set of climbing sticks of claim 13, wherein when in a stacked configuration, the second upper brace is positioned over and aligned with the first magnet.

15. The set of climbing sticks of claim 14, wherein the second upper brace comprises:
a connection portion extending around the second support bar;
a channel integral with the connection portion;
a first jaw extending away from the channel and supporting a first plurality of teeth; and
a second jaw extending away from the channel and supporting a second plurality of teeth;
wherein the channel is configured to receive the first support bar at of the position of the first magnet; and
wherein the channel at least partially wraps around the first support bar.

16. The set of climbing sticks of claim 12, wherein the first climbing stick further comprises a second magnet attached to the first support bar at a position above the first lower brace, and wherein the second climbing stick is configured to secure to the first climbing stick via the second magnet.

17. The set of climbing sticks of claim 12, wherein the first top foot rung further comprises:
a front side having a plurality of irregularly shaped openings extending therethrough;
a back side having a plurality of irregularly shaped openings extending therethrough; and
one or more spacers positioned between the front side and the back side such that a gap is created between the front side and the back side;
wherein the first support bar is secured between the front side and the back side.

18. The set of climbing sticks of claim 12, wherein the first climbing stick further comprises a height of approximately 20 inches, a distance between a top of the first top foot rung and a top of the first bottom foot rung of approximately 18 inches, and a weight of approximately 1.75 pounds.

19. The set of climbing sticks of claim 12, wherein the first climbing stick further comprises a height of approximately 17 inches, a distance between a top of the top foot rung and a top of the bottom foot rung of approximately 15 inches, and a weight of approximately 1.6 pounds.

20. The set of climbing sticks of claim 12, wherein the first climbing stick further comprises a long bolt extending through the bottom foot rung and the support bar, the long bolt extending outward from the bottom foot rung.
